(19) United States
(12) Patent Application Publication
(10) Pub. No.: US 2026/0291711 A1
(43) Pub. Date: Sep. 24, 2026

(54) METHOD AND SYSTEM FOR MULTI-ORGANIZATION JOINT VARIETY YIELD PREDICTION WITH DATA PRIVACY PROTECTION

(71) Applicant: Information Technology Research Center, Beijing Academy of Agriculture and Forestry Sciences, Beijing (CN)

(72) Inventors: Qiusi ZHANG, Beijing (CN); Kaiyi WANG, Beijing (CN); Dongfeng ZHANG, Beijing (CN); Shufeng WANG, Beijing (CN); Zhongqiang LIU, Beijing (CN); Yanyun HAN, Beijing (CN); Shouhui PAN, Beijing (CN); Xiangyu ZHAO, Beijing (CN); Feng YANG, Beijing (CN); Baoqi YAN, Beijing (CN)

(21) Appl. No.: 19/255,643

(22) Filed: Jun. 30, 2025

(30) Foreign Application Priority Data
Mar. 18, 2025 (CN) 202510316784.7

(51) Int. Cl. H04L 9/08; G06N 5/01

(52) U.S. Cl. CPC H04L 9/0819; G06N 5/01

(57) ABSTRACT

A method and system for multi-organization joint variety yield prediction with data privacy protection are provided. The method includes: determining a local optimal partition feature with a minimum degree of difference in a local partition feature set as a global optimal partition feature; obtaining ciphertext sample sets of a left subtree and a right subtree transmitted by a target client corresponding to the global optimal partition feature; broadcasting the ciphertext sample sets of the left and right subtrees to other clients among the multiple local clients, such that the other clients generate tree nodes with the same structure as the target client; constructing multiple decision trees according to preset parameters until a federated isomorphic forest model is completed; performing prediction on a to-be-predicted test set among the multiple local clients based on the federated isomorphic forest model to obtain a yield prediction result of the target variety.

### CROSS REFERENCE TO RELATED APPLICATION

This application claims the benefit of and priority to Chinese Patent Application No. 202510316784.7, filed Mar. 18, 2025, which is hereby incorporated by reference herein in its entirety.

### TECHNICAL FIELD

The present disclosure relates to the technical field of variety yield prediction, and in particular, to a method and system for multi-organization joint variety yield prediction with data privacy protection.

### BACKGROUND

Big data-driven artificial intelligence technologies, such as machine learning, are widely used in variety yield prediction. However, new artificial intelligence technologies often require a large amount of training data to perform well, which is unrealistic in many cases. Most breeding organizations typically have a limited number of trial sites, lacking sufficient data to independently train machine learning models.

However, breeding data, especially crop phenotype data obtained through complex and time-consuming field trials, is considered a relatively private asset for each breeding organization and is difficult to share.

Therefore, the variety yield prediction methods in the prior art face technical issues due to the security and privacy protection of breeding data, which limits multi-organization collaboration.

### SUMMARY

The present disclosure provides a method and system for multi-organization joint variety yield prediction with data privacy protection, to solve the defect of limited multi-organization collaboration in existing variety yield prediction methods, allowing multiple parties to conduct joint variety yield predictions without disclosing or sharing their own data.

The present disclosure provides a method for multi-organization joint variety yield prediction with data privacy protection, which includes the following steps: notifying multiple local clients separately based on randomly selected target samples and target features corresponding to a target variety, where a local training dataset of each local client includes the target samples and the target features; obtaining local optimal partition features transmitted by the multiple local clients to form a local partition feature set, where for each local client among the multiple local clients, the local optimal partition feature is a sample feature with a minimum degree of difference between predicted values and true values within a data range of the target samples and the target features; determining a local optimal partition feature with a minimum degree of difference in the local partition feature set as a global optimal partition feature; obtaining ciphertext sample sets of a left subtree and a right subtree transmitted by a target client corresponding to the global optimal partition feature; broadcasting the ciphertext sample sets of the left and right subtrees to other clients among the multiple local clients, such that the other clients generate tree nodes with the same structure as the target client; repeating the above steps to construct multiple decision trees according to preset parameters until a federated isomorphic forest model is completed; performing prediction on a to-be-predicted test set among the multiple local clients based on the federated isomorphic forest model to obtain a yield prediction result of the target variety.

According to the method for multi-organization joint variety yield prediction with data privacy protection provided by the present disclosure, said performing prediction on the to-be-predicted test set among the multiple local clients based on the federated isomorphic forest model to obtain the yield prediction result of the target variety includes: invoking the multiple local clients, and descending from a root node of each tree of the federated isomorphic forest model of the local client for each sample of the to-be-predicted test set until all samples of the to-be-predicted test set fall into leaf nodes, to obtain a leaf node sample set; obtaining the leaf node sample set of each local client among the multiple local clients; performing intersection based on the leaf node sample set of each local client to obtain the to-be-predicted test set; determining an average label value corresponding to the leaf node where each sample to be predicted in the to-be-predicted test set is located; and determining the yield prediction result of the target variety based on the average label value corresponding to the leaf node where each sample to be predicted is located.

According to the method for multi-organization joint variety yield prediction with data privacy protection provided by the present disclosure, said descending from the root node of each tree of the federated isomorphic forest model of the local client for each sample of the to-be-predicted test set until all samples of the to-be-predicted test set fall into leaf nodes, to obtain the leaf node sample set includes: taking each sample of the to-be-predicted test set as a current sample and recursively executing the following steps until all samples of the to-be-predicted test set fall into leaf nodes to obtain the leaf node sample set: when a current node of the federated isomorphic forest model of the local client carries partition information, classifying the current sample to a target leaf node based on the partition information, where the target leaf node includes a left subtree leaf node and a right subtree leaf node; and when the current node of the federated isomorphic forest model of the local client is a null node, making the current sample fall simultaneously into a left subtree leaf node and a right subtree leaf node of the null node.

According to the method for multi-organization joint variety yield prediction with data privacy protection provided by the present disclosure, before said notifying multiple local clients separately based on the randomly selected target samples and target features corresponding to the target variety, the method further includes: distributing an encryption algorithm and a public key to multiple system clients; invoking each system client among the multiple system clients to encrypt sample indices and feature encodings of a local training dataset of each system client according to the encryption algorithm and the public key, resulting in a sample index set and a feature encoding set; and obtaining the sample index set and feature encoding set from each system client among the multiple system clients.

According to the method for multi-organization joint variety yield prediction with data privacy protection provided by the present disclosure, before said obtaining the local optimal partition features transmitted by the multiple local clients to form the local partition feature set, the method further includes: invoking each local client among the multiple local clients to traverse each sample value of each feature in the local training dataset; partitioning the local training dataset into a left dataset and a right dataset based on each sample value of each feature; calculating a sum of a mean squared error of the left dataset and a mean squared error of the right dataset as a mean squared error for each sample value; and determining a feature corresponding to a sample value with a smallest mean squared error as a local optimal partition feature of the local training dataset.

According to the method for multi-organization joint variety yield prediction with data privacy protection provided by the present disclosure, after said broadcasting the ciphertext sample sets of the left and right subtrees to other clients among the multiple local clients, such that the other clients generate tree nodes with the same structure as the target client, the method further includes: when generating the tree nodes, determining generalization of a decision tree corresponding to the tree nodes based on pre-pruning conditions; and when the generalization of the decision tree decreases, performing pruning on the tree nodes.

The present disclosure further provides a system for multi-organization joint variety yield prediction with data privacy protection, including the following modules: a notification module configured to notify multiple local clients separately based on randomly selected target samples and target features corresponding to a target variety, where a local training dataset of each local client includes the target samples and the target features; an obtaining module configured to obtain local optimal partition features transmitted by the multiple local clients to form a local partition feature set, where for each local client among the multiple local clients, the local optimal partition feature is a sample feature with a minimum degree of difference between predicted values and true values within a data range of the target samples and the target features; a determining module configured to determine a local optimal partition feature with a minimum degree of difference in the local partition feature set as a global optimal partition feature, the obtaining module being further configured to obtain ciphertext sample sets of a left subtree and a right subtree transmitted by a target client corresponding to the global optimal partition feature; a broadcasting module configured to broadcast the ciphertext sample sets of the left subtree and the right subtree to other clients among the multiple local clients, such that the other clients generate tree nodes with the same structure as the target client; a construction module configured to repeat the above steps to construct multiple decision trees according to preset parameters until a federated isomorphic forest model is completed; and a prediction module configured to perform prediction on a to-be-predicted test set among the multiple local clients based on the federated isomorphic forest model to obtain a yield prediction result of the target variety.

The present disclosure further provides an electronic device, including a memory, a processor, and a computer program that is stored in the memory and able to run in the processor. When the program is executed by the processor, the method for multi-organization joint variety yield prediction with data privacy protection according to any one of the foregoing optional implementations is implemented.

The present disclosure further provides a non-transitory computer-readable storage medium that stores a computer program. When the computer program is executed by a processor, the method for multi-organization joint variety yield prediction with data privacy protection according to any one of the foregoing optional implementations is implemented.

The present disclosure further provides a computer program product, including a computer program. When the computer program is executed by a processor, the method for multi-organization joint variety yield prediction with data privacy protection according to any one of the foregoing optional implementations is implemented.

The method and system for multi-organization joint variety yield prediction with data privacy protection provided by the present disclosure ensure the diversity and representativeness of data by randomly selecting target samples and target features. At the same time, all clients that possess these samples and features in their local training datasets are notified, preparing for subsequent multi-organization joint predictions. Each local client independently identifies the sample feature with the minimum degree of difference between predicted values and true values as the local optimal partition feature based on its local training dataset, fully utilizing the data resources of each client while avoiding direct data sharing, thus protecting data privacy. By comparing the differences in local optimal partition features, a global optimal partition feature is selected, leveraging the advantages of multi-organization collaboration. By broadcasting ciphertext sample sets of the left and right subtrees corresponding to the global optimal partition feature, and invoking other clients to generate tree nodes with the same structure as the target client, information synchronization and model construction consistency among multiple parties are achieved. By iteratively executing the above steps, multiple decision trees are constructed, forming a federated isomorphic forest model, which enhances the robustness and predictive capability of the model. Using the constructed federated isomorphic forest model, predictions are made on the to-be-predicted test set among the various local clients, obtaining the yield prediction result for the target variety, thus achieving multi-organization joint variety yield prediction while protecting data privacy.

### BRIEF DESCRIPTION OF THE DRAWINGS

To describe the technical solutions in the embodiments of the present disclosure or in the prior art more clearly, the following briefly describes the drawings required for describing the embodiments or the prior art. Apparently, the drawings in the following description show some embodiments of the present disclosure, and a person of ordinary skill in the art may still derive other drawings from these drawings without creative efforts.

FIG. 1 is a schematic flowchart of a method for multi-organization joint variety yield prediction with data privacy protection according to the present disclosure;

FIG. 2 is a schematic flowchart of a decision tree construction process according to the present disclosure;

FIG. 3 is a schematic flowchart of a process in which to-be-predicted samples fall into leaf nodes according to the present disclosure;

FIG. 4 is a schematic structural diagram of a system for multi-organization joint variety yield prediction with data privacy protection according to the present disclosure; and

FIG. 5 is a schematic physical structure diagram of an electronic device according to the present disclosure.

### DETAILED DESCRIPTION OF THE EMBODIMENTS

To make the objectives, technical solutions and advantages of the present disclosure clearer, the following clearly and completely describes the technical solutions in the present disclosure with reference to the accompanying drawings in the present disclosure. Apparently, the described embodiments are some but not all of the embodiments of the present disclosure. All other embodiments obtained by those skilled in the art based on the embodiments of the present disclosure without creative efforts shall fall within the protection scope of the present disclosure.

The present disclosure relates to the field of crop variety yield prediction, specifically to a method and system for multi-organization joint yield prediction based on federated learning with data security and privacy protection as a prerequisite.

In recent years, big data-driven artificial intelligence technologies, such as machine learning, have been widely applied in variety yield prediction, demonstrating impressive results. However, new artificial intelligence technologies often require a large amount of training data to perform well, which is unrealistic in many cases. Most breeding entities typically have a limited number of trial sites, lacking sufficient data to independently train machine learning models. Additionally, due to barriers, it is difficult for different breeding entities to collaborate openly, making it challenging to achieve the sharing of advantageous germplasm resources among entities. Therefore, the importance of breaking through the barriers among breeding entities to conduct joint yield predictions is increasingly prominent in intelligent breeding scenarios.

However, breeding data, especially crop phenotype data obtained through complex and time-consuming field trials, is an extremely valuable asset for each breeding organization, which is vital for each breeding unit and is difficult to share due to its sensitivity. The inability to share data creates a significant contradiction with the demand for joint breeding, and competitive interests among different entities affect the possibility of cooperation and openness that could benefit all parties in terms of data sharing.

Therefore, the application of federated learning in the field of variety yield prediction can address the needs of many breeding entities for joint breeding. Researching key technologies for variety yield prediction based on federated learning with data security and privacy protection as a prerequisite is of great significance, enabling many breeding entities to collaborate without disclosing or sharing their own data and to jointly benefit from the new generation of artificial intelligence technologies.

To address the deficiencies in the existing technology, the present disclosure combines trait phenotype data collected from early field trials of varieties with meteorological data from the experimental sites, proposing a method and system for multi-organization joint yield prediction with data security and privacy protection as a prerequisite to solve the aforementioned problems.

The present disclosure proposes a new method called federated isomorphic forest, which is based on the framework of federated learning technology and the random forest algorithm. This method coordinates all clients to jointly construct decision trees and share the same model structure for multi-organization joint yield prediction. A significant advantage of this method is its compatibility with both horizontal and vertical federated learning scenarios.

It should be noted that, based on the differences in island data distribution, federated learning scenarios can be divided into three main categories: horizontal federated learning refers to scenarios where clients have the same features but different samples; vertical federated learning refers to scenarios where clients have the same samples but different features; and federated transfer learning refers to scenarios where clients have neither the same samples nor the same features. Existing methods primarily address horizontal federated issues.

Optionally, the method for multi-organization joint variety yield prediction with data privacy protection in the embodiment of the present disclosure can be executed by a server, by a terminal device, or jointly by the server and terminal device. For example, the method for multi-organization joint variety yield prediction with data privacy protection in this embodiment is executed by a server (server side).

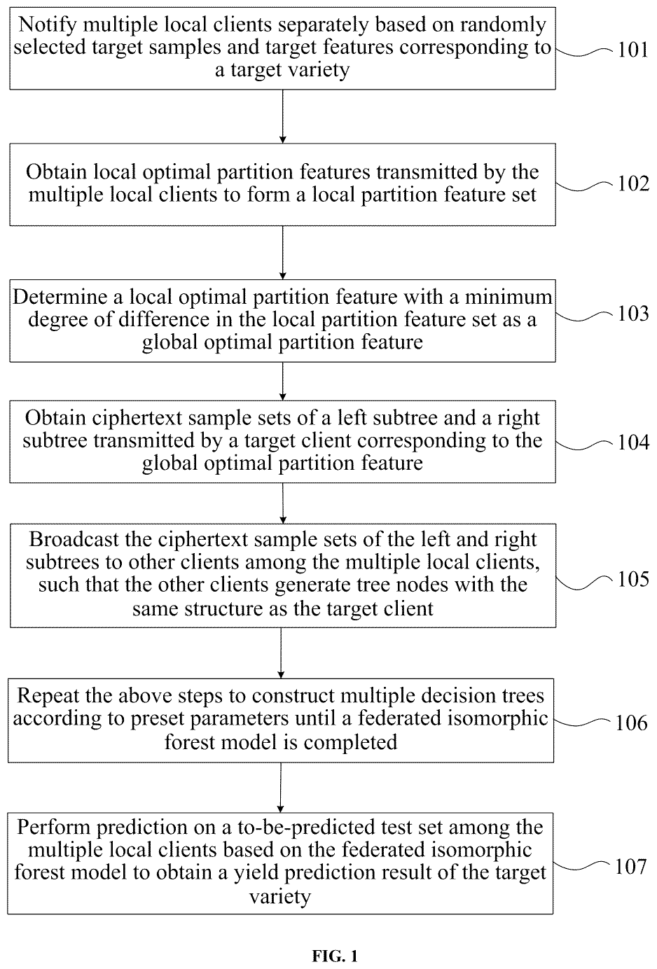

FIG. 1 is a schematic flowchart of a method for multi-organization joint variety yield prediction with data privacy protection according to the present disclosure. As shown in FIG. 1, the method includes the following steps:

Step 101: Notify multiple local clients separately based on randomly selected target samples and target features corresponding to a target variety.

A local training dataset of each local client includes the target samples and the target features.

In this embodiment of the present disclosure, the server randomly selects target samples and target features corresponding to the target variety and notifies all local clients whose local training datasets include the target samples and target features.

The server initially randomly selects a subset of samples S′ CS and features F′ c F, where S′ represents the target samples, S represents a global sample set corresponding to all clients, F′ represents the target features, and F represents a global feature set corresponding to all clients. The server privately notifies all clients that possess the target samples and target features in their local data (local training datasets).

In other words, local client i only knows that certain samples and features in its local data have been selected, but does not know which samples and features of other clients have been selected, nor does it know how many samples and features the server has selected in total.

Step 102: Obtain local optimal partition features transmitted by the multiple local clients to form a local partition feature set.

For each local client among the multiple local clients, the local optimal partition features is a sample feature with a minimum degree of difference between predicted values and true values within a data range of the target samples and the target features.

In this embodiment of the present disclosure, for each notified local client i, the locally selected samples are within the data range of the target samples (Sᵢ⊆S′) and the locally selected features are within the data range of the target features (Fᵢ⊆F′). By calculating the degree of difference between the predicted values and true values of the selected samples, the local optimal partition feature

$${f}_{i}^{*}$$

for local client i is determined, and then the local optimal partition feature

$${f}_{i}^{*}$$

along with its corresponding difference measure is sent to the server.

The server obtains the local optimal partition features transmitted by each local client among the multiple local clients and constructs the local partition feature set.

Furthermore, the calculation of the degree of difference between predicted values and true values can be performed through classification tasks or regression tasks. Generally, classification tasks can use the Gini index or entropy, while regression tasks can use mean squared error (MSE) and mean absolute error (MAE).

Through this embodiment of the present disclosure, each local client independently identifies the sample feature with the minimum degree of difference between predicted values and true values as the local optimal partition feature based on its local training dataset. This step fully utilizes the data resources of each client while avoiding direct data sharing, thus protecting data privacy.

Step 103: Determine a local optimal partition feature with a minimum degree of difference in the local partition feature set as a global optimal partition feature.

In this embodiment of the present disclosure, the feature

$${f}_{k}^{*}$$

with the minimum mean squared error among all local optimal partition features sent from the local clients is selected and confirmed as the global optimal partition feature f* for this round.

Through this embodiment of the present disclosure, the global optimal partition feature is selected by comparing the differences in the local optimal partition features. This step ensures consistency and accuracy in the model construction process while reflecting the advantages of multi-organization joint prediction.

Step 104: Obtain ciphertext sample sets of a left subtree and a right subtree transmitted by a target client corresponding to the global optimal partition feature.

In this embodiment of the present disclosure, after receiving the local optimal partition features sent by all local clients, the server selects the feature with the optimal (minimum) difference measure and confirms it as the global optimal partition feature f*. The server then notifies the target client k corresponding to the global optimal partition feature f* to perform left and right subtree partitioning and to save detailed partition information (including partition features and corresponding partition thresholds) at the current partition node.

The target client k sends the ciphertext sample sets of the left and right subtrees, left_index and right_index, to the server. The server obtains the ciphertext sample sets of the left and right subtrees transmitted by the target client corresponding to the global optimal partition feature.

Through this embodiment of the present disclosure, the target client partitions its local training dataset into left and right subtrees based on the global optimal partition feature and transmits the sample sets in the form of ciphertext. This step protects data privacy while providing a basis for other clients to generate tree nodes with the same structure.

Step 105: Broadcast the ciphertext sample sets of the left subtree and the right subtree to other clients among the multiple local clients, such that the other clients generate tree nodes with the same structure as the target client.

In this embodiment of the present disclosure, the target client k sends the ciphertext sample sets of the left and right subtrees, left_index and right_index, to the server. The server then broadcasts the ciphertext sample sets to other clients, allowing the other clients to generate tree nodes with the same structure but without detailed information.

Through this embodiment of the present disclosure, the ciphertext sample sets are broadcast to other clients such that the other clients can generate tree nodes with the same structure as the target client based on the ciphertext samples of the left and right subtrees. This step achieves information synchronization among multiple parties and consistency in model construction.

Step 106: Repeat the above steps to construct multiple decision trees according to preset parameters until a federated isomorphic forest model is completed.

Steps S101 to S105 are iteratively executed until a decision tree is fully constructed. During this process, pre-pruning conditions are checked during generation of each node in the tree. Pre-pruning is one of the main tools used in decision tree algorithms in machine learning to address the risk of overfitting. The main idea is to calculate the impact of generating each node on the generalization performance of the entire tree. If the generalization decreases, the node is pruned directly, and the client and server correspondingly create leaf nodes l.

In this embodiment of the present disclosure, the above steps are repeatedly executed to continuously construct multiple decision trees until the entire federated isomorphic forest model is completed.

Through this example of the present disclosure, multiple decision trees are constructed by iteratively executing the above steps, forming a federated isomorphic forest model. This step enhances the robustness and predictive capability of the model, as the combination of multiple decision trees can improve the accuracy and stability of predictions.

Step 107: Perform prediction on a to-be-predicted test set among the multiple local clients based on the federated isomorphic forest model to obtain a yield prediction result of the target variety.

In this embodiment of the present disclosure, the federated isomorphic forest model is jointly trained by multiple local clients while protecting data privacy. Each local client performs training based on its local training dataset (containing the target samples and target features) and contributes its local optimal partition feature. The local optimal partition features are aggregated and used to determine the global optimal partition feature, thereby constructing the nodes of the decision trees. By repeating this process, a federated isomorphic forest model composed of multiple decision trees is constructed.

In the federated isomorphic forest model, the prediction process can be distributed, with each decision tree (or a subset of trees) assigned to one or more local clients for prediction. The local clients utilize their local resources and computational capabilities to predict the samples in the test set and generate prediction results. The prediction results can be classification labels (for classification problems) or regression values (for regression problems, such as yield prediction).

The prediction results from all local clients need to be aggregated at a central server (the server end) or a designated client. During the aggregation process, it may be necessary to decrypt the prediction results (if the prediction results were previously encrypted). The central server (the server end) or the designated client can then perform further processing and analysis on these results, such as calculating the average, median, or other statistics to obtain the final yield prediction result.

Through the above steps of the embodiment of the present disclosure, the diversity and representativeness of data can be ensured by randomly selecting target samples and target features. At the same time, all clients that possess these samples and features in their local training datasets are notified, preparing for subsequent multi-organization joint predictions. Each local client independently identifies the sample feature with the minimum degree of difference between predicted values and true values as the local optimal partition feature based on its local training dataset, fully utilizing the data resources of each client while avoiding direct data sharing, thus protecting data privacy. By comparing the differences in local optimal partition features, a global optimal partition feature is selected, leveraging the advantages of multi-organization collaboration. By broadcasting ciphertext sample sets of the left and right subtrees corresponding to the global optimal partition feature, and invoking other clients to generate tree nodes with the same structure as the target client, information synchronization and model construction consistency among multiple parties are achieved. By iteratively executing the above steps, multiple decision trees are constructed, forming a federated isomorphic forest model, which enhances the robustness and predictive capability of the model. Using the constructed federated isomorphic forest model, predictions are made on the to-be-predicted test set among the various local clients, obtaining the yield prediction result for the target variety, thus achieving multi-organization joint variety yield prediction while protecting data privacy.

According to the method for multi-organization joint variety yield prediction with data privacy protection provided by the present disclosure, the step of performing prediction on the to-be-predicted test set among the multiple local clients based on the federated isomorphic forest model to obtain the yield prediction result of the target variety includes:
invoking the multiple local clients, and for each sample of the to-be-predicted test set, descending from a root node of each tree of the federated isomorphic forest model of the local client until all samples of the to-be-predicted test set fall into leaf nodes, to obtain a leaf node sample set;
obtaining the leaf node sample set of each local client among the multiple local clients;
performing intersection based on the leaf node sample set of each local client to obtain the to-be-predicted test set;
determining an average label value corresponding to the leaf node where each sample to be predicted in the to-be-predicted test set is located; and
determining the yield prediction result of the target variety based on the average label value corresponding to the leaf node where each sample to be predicted is located.

In this embodiment of the present disclosure, each local client sends its local set of samples that fall into the leaf nodes (that is, the leaf node sample set)

$${S}_{i} = \{ {S}_{i}^{1} , {S}_{i}^{2} , … , {S}_{i}^{l} \}$$

(where Sᵢ represents the leaf node sample set of the i-th local client, and

$${S}_{i}^{l}$$

represents the l-th leaf node sample in the leaf node sample set of the i-th local client) to the server. The server obtains the leaf node sample set from each local client among the multiple local clients.

After aggregating the leaf node sample sets {S₁, S₂, . . . , Sₘ} from all m clients (where Sₘ represents the leaf node sample set of the m-th local client, and m represents the total number of clients), the server performs an intersection operation to obtain a set of to-be-predicted samples that actually fall into the leaf nodes (that is, the to-be-predicted test set) {S¹, S², . . . , S^{l}}, where

$${S}^{l} = {S}_{1}^{l} ⋂ {S}_{2}^{l} ⋂ … ⋂ {S}_{m}^{l} ,$$

where S^{l} represents the l-th sample to be predicted, and

$${S}_{m}^{l}$$

represents the l-th leaf node sample in the leaf node sample set of the m-th local client.

Similar to the classical centralized random forest model used for regression tasks, once all the samples to be predicted have fallen into leaf nodes, the final yield prediction result can be easily obtained from the server by calculating the average of the labels corresponding to the leaf nodes where the samples are located.

In some embodiments, for each sample in the to-be-predicted test set, the process starts from the root node of each tree in the isomorphic random forest model of each local client. The sample gradually descends based on its feature values until the sample falls into a leaf node. This process is performed for all samples in the test set, ensuring that each sample can find the corresponding leaf node in the models of various local clients.

The server collects all the leaf nodes where the samples to be predicted fall in each local client, forming a leaf node sample set. This set contains all samples that fall into the same leaf node based on the features of the test set samples in each local client.

An intersection operation is performed on the leaf node sample sets from all local clients. A sample will only be included in the final to-be-predicted test set if it falls into the same leaf node across all clients. This step effectively serves as a consensus mechanism for the prediction results, ensuring the stability and reliability of the predictions.

For each sample in the to-be-predicted test set, the corresponding leaf nodes in various local clients are identified, and the average of the sample labels in these leaf nodes is calculated. The labels typically represent the actual yield values or other target variables.

Based on the average label values of each sample to be predicted, the final yield prediction result for the target variety is determined. The yield prediction result is a comprehensive consideration of the predictions from all local clients, reducing bias and improving prediction accuracy through intersection and averaging.

Through the embodiment of the present disclosure, relying on the framework of federated learning where data remains on local clients and is not processed centrally, data privacy is protected. At the same time, by using intersection and averaging, the prediction results from multiple clients can be fully utilized, enhancing the robustness and accuracy of the predictions.

According to the method for multi-organization joint variety yield prediction with data privacy protection provided by the present disclosure, the step of descending from the root node of each tree of the federated isomorphic forest model of the local client for each sample of the to-be-predicted test set until all samples of the to-be-predicted test set fall into leaf nodes, to obtain the leaf node sample set includes:
taking each sample of the to-be-predicted test set as a current sample and recursively executing the following steps until all samples of the to-be-predicted test set fall into leaf nodes to obtain the leaf node sample set:
when a current node of the federated isomorphic forest model of the local client carries partition information, classifying the current sample to a target leaf node based on the partition information, where the target leaf node includes a left subtree leaf node and a right subtree leaf node; and
when the current node of the federated isomorphic forest model of the local client is a null node, making the current sample fall simultaneously into a left subtree leaf node and a right subtree leaf node of the null node.

In this embodiment of the present disclosure, the completed federated isomorphic forest model is used for batch yield prediction. In each local client i, for each sample

$$s ∈ {S}_{i}^{test}$$

in the to-be-predicted test set (where

$${S}_{i}^{test}$$

represents the samples to be predicted for local client i), the process starts from the root node of each tree in the locally stored federated isomorphic forest model and descends.

If the current node of the local model contains detailed partition information, it is determined whether the sample s falls into the left subtree or right subtree based on the partition feature and threshold. If the current node is null, the sample s falls into both the left and right subtrees.

The above steps are recursively performed until all samples to be predicted fall into one or more leaf nodes l∈L of each tree.

Through this embodiment of the present disclosure, under the framework of federated learning, data is retained on local clients without being centralized in one location, reducing the risk of data leakage and protecting the privacy of users or organizations. Each local client independently trains models on its data and collaborates with other clients through model parameter updates or the aggregation of prediction results, thereby achieving knowledge sharing without directly sharing raw data.

According to the method for multi-organization joint variety yield prediction with data privacy protection provided by the present disclosure, before the step of notifying multiple local clients separately based on the randomly selected target samples and target features corresponding to the target variety, the method further includes:
distributing an encryption algorithm and a public key to multiple system clients;
invoking each system client among the multiple system clients to encrypt sample indices and feature encodings of a local training dataset of each system client according to the encryption algorithm and the public key, resulting in a sample index set and a feature encoding set; and
obtaining the sample index set and feature encoding set from each system client among the multiple system clients.

In this embodiment of the present disclosure, a (central) server specifies and manages a unified encryption algorithm and public key (key), distributing them to all system clients.

Furthermore, the encryption algorithm is used to ensure the privacy and security of local data of each client, and any encryption algorithm can be used based on actual needs. Since the server only needs to align features and samples based on data ciphertext and does not need to perform decryption, a hash encryption algorithm represented by MD5 can be used for one-way, irreversible encryption, making client data more secure.

In this embodiment of the present disclosure, the MD5 algorithm is used, and an initial public key is specified and distributed to all system clients.

Each system client encrypts all sample indices and feature encodings in its local training dataset according to the unified encryption algorithm and key, and then sends them to the server for aggregation. Thus, the server holds the sample index set and feature encoding set of all data but does not know the true meaning of these features and samples, nor does it know what all the data actually is.

Here, the system client is a client that is pre-associated with the server, and the system client whose local training dataset includes the target samples and target features randomly selected by the server will act as a local client.

Through this embodiment of the present disclosure, hash encryption algorithms like MD5 are used for one-way, irreversible encryption, which further enhances data security. This encryption method ensures that even if data is intercepted, attackers cannot obtain the original data through decryption, thus protecting the integrity and authenticity of the data. Although the server cannot decrypt the data, it can still align features and samples based on the encrypted data (such as sample indices and feature encodings), allowing the server to effectively process and analyze the data without exposing the original data.

According to the method for multi-organization joint variety yield prediction with data privacy protection provided by the present disclosure, before the step of obtaining the local optimal partition features transmitted by the multiple local clients to form the local partition feature set, the method further includes:
invoking each local client among the multiple local clients to traverse each sample value of each feature in the local training dataset;
partitioning the local training dataset into a left dataset and a right dataset based on each sample value of each feature;
calculating a sum of a mean squared error of the left dataset and a mean squared error of the right dataset as a mean squared error for each sample value; and
determining a feature corresponding to a sample value with a smallest mean squared error as a local optimal partition feature of the local training dataset.

In this embodiment of the present disclosure, the local optimal partition feature

$${f}_{i}^{*}$$

for each local client is determined by calculating the mean squared error mse. The specific calculation steps are as follows: First, each sample value value of each feature f∈Fᵢ is traversed (where f represents the current feature and Fᵢ represents the feature set of local client i), and Sᵢ is partitioned into two sets S_{left} (≤value) and S_{right} (>value). Then, mse is calculated for both sets using the following formulas:

$$mean = \frac{1}{n} {\sum }_{j = 1}^{n} label ( j ) ;$$

$$mse = \frac{1}{n} {\sum }_{j = 1}^{n} {( label ( j ) - mean )}^{2} ;$$

where mean represents the average value, n is the number of samples in the local training dataset of local client i, label (j) is the label value corresponding to sample j, and mse represents the mean squared error.

Finally, the total mse=mse_{left}+mse_{right} is calculated (where mse represents the mean squared error of the sample value, and mse_{left} and mse_{right} represent the mean squared errors of the left dataset and the right dataset, respectively) and the feature with the smallest mse is selected as the local optimal partition feature

$${f}_{i}^{*} .$$

At the same time, the sample value value is the local optimal partition threshold. Then the local optimal partition feature

$${f}_{i}^{*}$$

and the corresponding mse value are sent to the server.

Mean squared error (MSE) is a common metric for measuring the performance of prediction models. It represents the average of the squares of the differences between predicted values and actual values. A smaller MSE value indicates better predictive performance of the model, because it means the differences between predicted values and actual values are smaller.

Through this embodiment of the present disclosure, the average value can be used to understand the central tendency of the data, while the mean squared error can be used to measure the prediction accuracy of the model.

According to the method for multi-organization joint variety yield prediction with data privacy protection provided by the present disclosure, after the step of broadcasting the ciphertext sample sets of the left and right subtrees to other clients among the multiple local clients, such that the other clients generate tree nodes with the same structure as the target client, the method further includes:
when generating the tree nodes, determining generalization of a decision tree corresponding to the tree nodes based on pre-pruning conditions; and
when the generalization of the decision tree decreases, performing pruning on the tree nodes.

In this embodiment of the present disclosure, during the construction of the decision tree, pre-pruning conditions are checked during generation of each node in the tree. Pre-pruning is one of the main tools used in decision tree algorithms in machine learning to address the risk of overfitting. The main idea is to calculate the impact of generating each node on the generalization performance of the entire tree. If the generalization decreases, the node is pruned directly, and the client and server correspondingly create leaf nodes l.

Pre-pruning is a technique that stops the splitting of tree nodes early during the decision tree generation process, aiming to prevent the decision tree from overfitting the training data. Before splitting at each node of the decision tree, it is evaluated based on the predefined pruning conditions whether the split can enhance the generalization ability of the decision tree. These pruning conditions may include:

Reduction in information gain/Gini impurity/entropy: If the reduction in information gain, Gini impurity, or entropy of the child nodes after the split is below a specific threshold, it is considered that the split does not provide a significant improvement in generalization ability, and thus the split is stopped.

Number of samples in the node: If the number of samples in the node is less than a specific threshold, the split is stopped to avoid overfitting in cases of sparse samples.

Validation set accuracy/loss: An independent validation set is used to assess the change in accuracy or loss before and after the split. If there is no significant improvement in validation set performance after the split, the split is stopped.

By applying these pre-pruning conditions, unnecessary splits can be terminated early during the decision tree construction process, thereby maintaining the simplicity and generalization ability of the decision tree.

Pruning typically includes the following methods:

Post-Pruning: After the decision tree is fully generated, the decision tree is traversed upwards from the leaf nodes. If the performance of a subtree of an internal node on the validation set is worse than the performance achieved in the case where the internal node is replaced with a leaf node (which belongs to the most frequent category among the samples of the subtree), pruning is performed.

Cost Complexity Pruning: A pruning parameter is introduced to control the complexity of the decision tree; a larger parameter value indicates more severe pruning. The optimal pruning parameter is then selected using methods such as cross-validation.

Error Reduction Pruning: An independent validation set is used to evaluate the change in error rate before and after pruning. If the error rate decreases after pruning, then pruning is performed.

Through this embodiment of the present disclosure, the goal of pruning is to remove parts that do not significantly contribute to the generalization ability of the decision tree, resulting in a more concise decision tree with better generalization ability.

The following describes an example of the method for multi-organization joint variety yield prediction with data privacy protection provided by the present disclosure in practical applications.

It should be noted that the target crop in the embodiments of the present disclosure can be any existing crop, such as corn, rice, cotton, wheat, and soybeans; the present disclosure does not impose specific limitations in this regard.

It should be noted that in the embodiments of the present disclosure, the target crop being corn is taken as an example to detail the technical solutions of the embodiments of the present disclosure.

The multi-organization joint yield prediction method proposed in this embodiment of the present disclosure includes the following steps.

Step S1: Each participating breeding organization acts as a client in the system, represented as i. Each local client i constructs its own local training dataset, denoted as Di, which includes variety trial data and meteorological environmental data. All varieties to be predicted of the clients and the varieties used as training data should belong to the same crop. Each data entry in the local training dataset represents a field trial completed by an organization for a specific variety at a particular experimental site, and each entry is represented by a six-tuple {organization, variety, experimental site, trial year, trait feature set, meteorological index set}.

Furthermore, the trait feature set in step S1 includes phenological periods, agronomic traits, pest grouping survey items, and specified test traits.

Additionally, the meteorological index set in step S1 includes temperature, humidity, atmospheric pressure, wind, sunlight, and so on. These meteorological data should be periodic statistical values during the entire growth period of each variety trial. The mean and variance of each meteorological index during the period can be further calculated and collectively used as training data features.

It should be noted that this method requires extensive data communication and mathematical calculations between the server and the participating breeding entities. Therefore, the scale of cooperating entities applicable to the method will be limited by computational power and network bandwidth resources. The greater the computational power and the faster the network communication, the more cooperating entities can be supported.

Step S2: A central server specifies and manages a unified encryption algorithm and public key (key), and distributes the encryption algorithm and the public key to all the clients.

Furthermore, the encryption algorithm in step S2 is used to ensure the privacy and security of the local data of each client, and any encryption algorithm can be used based on actual needs. Since the server only needs to align features and samples based on data ciphertext and does not need to perform decryption, a hash encryption algorithm represented by MD5 can be used for one-way, irreversible encryption, making client data more secure.

In this embodiment of the present disclosure, the MD5 algorithm is used, and an initial public key is specified and distributed to all clients.

Step S3: Each local client i encrypts all sample indices and feature encodings in its local training dataset Dᵢ according to the unified encryption algorithm and key, and then sends the encrypted sample indices and feature encodings to the server for aggregation. Thus, the server holds the sample index set and feature encoding set of all data but does not know the true meaning of these features and samples, nor does it know what all the data actually is.

In this embodiment of the present disclosure, the features and samples in the local training dataset of each client are first encoded according to standardized English abbreviations. For example, the encoding for plant height is PH (Plant Height), and the encoding for the mean maximum temperature is MaxTM (Maximum Temperature Mean). Subsequently, one-way, irreversible encryption is performed using the MD5 algorithm based on the key sent by the server. Table 1 and Table 2 provide several examples of feature encoding and sample encoding encryption. Finally, all encrypted ciphertexts of the feature encodings are sent to the server. Since each client uses standardized feature encodings and the same key for MD5 encryption, the ciphertexts of the same features are identical, which aids in feature alignment. At the same time, it is difficult for both the server and any external malicious attackers to decipher these ciphertexts to understand the true meaning of the features.

TABLE 1

| Feature | Encoding | Encrypted Text |
|---|---|---|
| Plant Height | PH | KfV59XQqIj5Z1wh25gcykw== |
| Maximum | MaxTM | HFoQR5YuXfjkRRmRQLV3Dg== |
| Temperature Mean | | |

TABLE 2

| Corn Variety | Encoding | Encrypted Text |
|---|---|---|
| Wugu 638 | wg638 | UGWiU2ZQA15GmgdSzI90YA== |
| Xianyu 1419 | xy1419 | Nib6xkNP+/MMNdbmV53JCQ== |

Step S4: The server initially randomly selects a subset of samples S′⊂S and features F′⊂F, and privately notifies all clients that possess these samples and features in their local data. In other words, the client only knows that certain samples and features in its local data have been selected, but does not know which samples and features of other clients have been selected, nor does it know how many samples and features the server has selected in total.

Step S5: Each notified local client i determines its local optimal partition feature

$${f}_{i}^{*}$$

within a data range of the selected samples Sᵢ⊆S' and features Fᵢ⊆F′ by calculating the degree of difference between predicted values and true values, and then sends the local optimal partition feature

$${f}_{i}^{*}$$

and its corresponding difference measure to the server.

Furthermore, in step S5, the degree of difference between predicted values and true values for general classification tasks can be measured using metrics such as the Gini coefficient or entropy, while mean squared error and mean absolute error can be used for regression tasks.

The embodiment of the present disclosure determines its local optimal partition feature

$${f}_{i}^{*}$$

by calculating mse. The specific calculation steps are as follows: First each sample value value of each feature f∈Fᵢ is traversed, and Sᵢ is partitioned into two sets S_{left} (≤value) and S_{right} (>value). Then, mse is calculated for both sets using the following formulas:

$$mean = \frac{1}{n} {\sum }_{j = 1}^{n} label ( j ) ;$$

$$mse = \frac{1}{n} {\sum }_{j = 1}^{n} {( label ( j ) - mean )}^{2} ;$$

where n is the number of samples in Sᵢ, and label (j) is a label value corresponding to sample j.

Finally, total mse=mse_{left}+mse_{right} is calculated, and a feature with the smallest mse is selected as the local optimal partition feature

$${f}_{i}^{*} .$$

At eh same time, the sample value value is the local optimal partition threshold, and then the local optimal partition feature

$${f}_{i}^{*}$$

and its mse value are sent to the server.

Step S6: After collecting information sent by all the clients, the server selects a feature with an optimal difference measure and confirms the selected feature as a global optimal partition feature f*; the server then informs a corresponding target client k to perform left and right subtree partitioning and to save detailed partition information (including the partition feature and the corresponding threshold) at the current partition node.

In this embodiment of the present disclosure, the feature

$${f}_{k}^{*}$$

with the minimum mse among the local optimal partition features sent by all the clients is selected and confirmed as the global optimal partition feature f* for this round.

Step S7: The target client k sends ciphertext sample sets left_index and right_index of the left and right subtrees to the server; the server then broadcasts the ciphertext sample sets to other clients, allowing the other clients to generate tree nodes with the same structure but without detailed information.

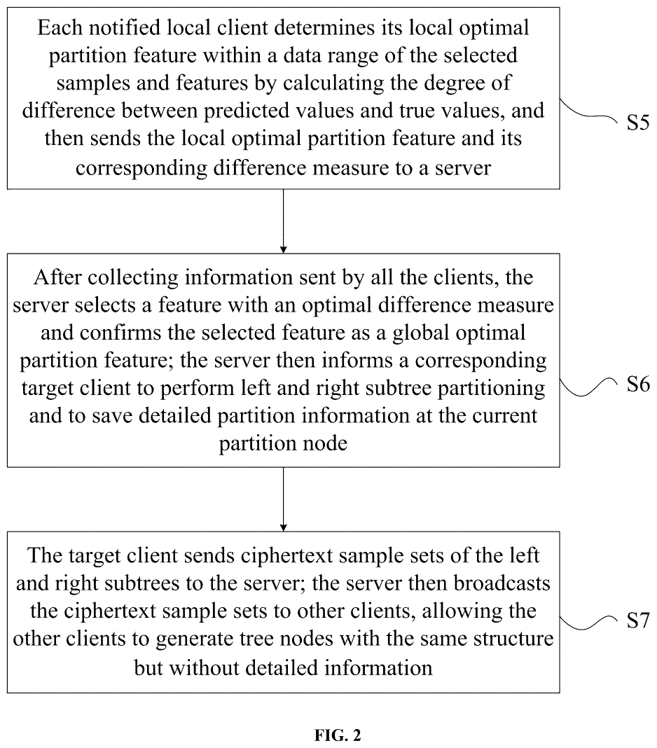

Referring to FIG. 2, which is a schematic flowchart of a decision tree construction process according to the present disclosure, this process includes steps S5 to S7.

Step S8: Iteratively perform steps S5 to S7 until a decision tree is fully constructed. During this process, pre-pruning conditions are checked during generation of each node in the tree. Pre-pruning is one of the main tools used in decision tree algorithms in machine learning to address the risk of overfitting. The main idea is to calculate the impact of generating each node on the generalization performance of the entire tree. If the generalization decreases, the node is pruned directly, and the client and server correspondingly create leaf nodes l.

Step S9: Throughout the entire federated learning network, continuously repeat the training steps as in steps S4 to S8, to continuously construct multiple decision trees according to preset parameters until the entire federated isomorphic forest model is completed.

Step S10: Use the trained model to perform batch yield predictions, where for each local client i, each sample

$$s ∈ {S}_{i}^{test}$$

in the to-be-predicted test set starts descending from the root node of each tree in the locally stored forest model.

Step S11: If the current node of the local model contains detailed partition information, determine whether sample s falls into the left subtree or the right subtree based on the partition feature and threshold; if the current node is null, sample s falls into both the left and right subtrees.

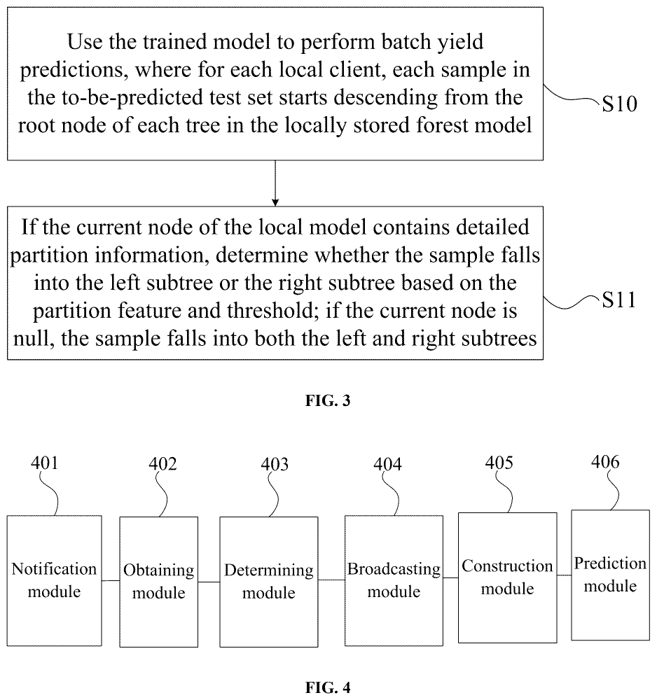

Referring to FIG. 3, which is a schematic flowchart of a process in which to-be-predicted samples fall into leaf nodes according to the present disclosure, the process includes steps S10 to S11.

Step S12: Recursively perform steps S10 to S11 until all samples to be predicted fall into one or more leaf nodes l∈L of each tree.

Step S13: Each local client i sends a local set of samples that fall into the leaf nodes,

$${S}_{i} = \{ {S}_{i}^{1} , {S}_{i}^{2} , … , {S}_{i}^{l} \} ,$$

to the server.

Step S14: After aggregating the leaf node sample sets {S₁, S₂, . . . , Sₘ} from all m clients, the server performs an intersection operation to obtain actual samples that fall into leaf nodes, resulting in a set of samples to be predicted that actually fall into leaf nodes, that is, {S¹, S², . . . , S^{l}}, where

$${S}^{l} = {S}_{1}^{l} ⋂ {S}_{2}^{l} ⋂ … ⋂ {S}_{m}^{l} .$$

Step S15: Similar to the classical centralized random forest model used for regression tasks, once all the samples to be predicted have fallen into leaf nodes, calculate an average of labels corresponding to the leaf nodes where the samples are located, thus easily obtaining a final yield prediction result from the server.

In this embodiment of the present disclosure, the dataset of each client is divided into a training set and a test set in a 4:1 ratio, meaning that 80% of the data is used as the training set, and the remaining 20% is used to test the prediction accuracy of the algorithm. The results obtained are {R²=0.805, RMSE=55.643, MAE=41.396}, indicating that the model trained in this embodiment of the present disclosure has excellent performance.

The R² value is a statistic that measures the goodness of fit of a regression model, indicating how well the regression model fits the observed values. It represents the percentage of the variance in the dependent variable that can be explained by the independent variables in the model. The R² value ranges from 0 to 1, with a larger R² value indicating a better fit of the regression model to the observed values.

RMSE, or root mean square error, is the arithmetic square root of the average of the squared errors and is the most commonly used evaluation metric for measuring prediction errors in regression models.

Mean absolute error (MAE), also known as L1 norm loss, is the average of the absolute errors. MAE can accurately reflect the magnitude of actual prediction errors, used to evaluate the degree of deviation between the true values and the fitted values. The closer the RMSE and MAE values are to 0, the better the model fit and the higher the prediction accuracy of the model.

The embodiments of the present disclosure provide a method and system for multi-organization joint yield prediction with data security and privacy protection as a premise. By comprehensively analyzing the variety trial data collected locally by each organization and the corresponding environmental meteorological data of the planting areas, a new method called federated isomorphic forest is introduced. Based on this method, a yield prediction model is jointly trained by multiple entities, helping a wide range of breeding entities, such as seed companies and research institutions, to overcome the challenges of data silos and the difficulty in sharing advantageous germplasm resources. This allows for joint modeling and intelligent prediction without the need to disclose or share their own data, thereby addressing the objective needs and practical issues of intelligent joint variety yield prediction.

The following describes a system for multi-organization joint variety yield prediction with data privacy protection provided by the present disclosure. The system described below corresponds to the method for multi-organization joint variety yield prediction with data privacy protection described above.

Referring to FIG. 4, FIG. 4 is a schematic structural diagram of a system for multi-organization joint variety yield prediction with data privacy protection according to the present disclosure.

A notification module 401 is configured to notify multiple local clients separately based on randomly selected target samples and target features corresponding to a target variety, where a local training dataset of each local client includes the target samples and the target features.

An obtaining module 402 is configured to obtain local optimal partition features transmitted by the multiple local clients to form a local partition feature set, where for each local client among the multiple local clients, the local optimal partition feature is a sample feature with a minimum degree of difference between predicted values and true values within a data range of the target samples and the target features.

A determining module 403 is configured to determine a local optimal partition feature with a minimum degree of difference in the local partition feature set as a global optimal partition feature.

The obtaining module 402 is further configured to obtain ciphertext sample sets of a left subtree and a right subtree transmitted by a target client corresponding to the global optimal partition feature.

A broadcasting module 404 is configured to broadcast the ciphertext sample sets of the left subtree and the right subtree to other clients among the multiple local clients, such that the other clients generate tree nodes with the same structure as the target client.

A construction module 405 is configured to repeat the above steps to construct multiple decision trees according to preset parameters until a federated isomorphic forest model is completed.

A prediction module 406 is configured to perform prediction on a to-be-predicted test set among the multiple local clients based on the federated isomorphic forest model to obtain a yield prediction result of the target variety.

Specifically, the system for multi-organization joint variety yield prediction with data privacy protection provided by the present disclosure can implement all the method steps achieved by the method for multi-organization joint variety yield prediction with data privacy protection, and can achieve the same technical effects. Therefore, the same parts and beneficial effects in this embodiment that correspond to the method embodiment will not be elaborated on herein.

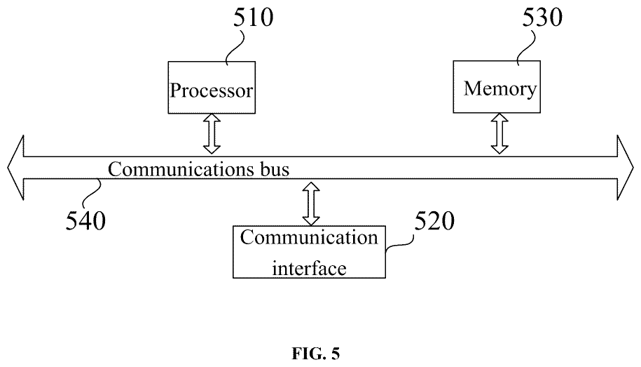

FIG. 5 is a schematic physical structure diagram of an electronic device according to the present disclosure. As shown in FIG. 5, the electronic device may include a processor 510, a communications interface 520, a memory 530, and a communications bus 540. The processor 510, the communications interface 520, and the memory 530 communicate with one another by means of the communications bus 540. The processor 510 can invoke logical instructions stored in the memory 530 to execute the method for multi-organization joint variety yield prediction with data privacy protection, which includes: notifying multiple local clients separately based on randomly selected target samples and target features corresponding to a target variety, where a local training dataset of each local client includes the target samples and the target features; obtaining local optimal partition features transmitted by the multiple local clients to form a local partition feature set, where for each local client among the multiple local clients, the local optimal partition feature is a sample feature with a minimum degree of difference between predicted values and true values within a data range of the target samples and the target features; determining a local optimal partition feature with a minimum degree of difference in the local partition feature set as a global optimal partition feature; obtaining ciphertext sample sets of a left subtree and a right subtree transmitted by a target client corresponding to the global optimal partition feature; broadcasting the ciphertext sample sets of the left and right subtrees to other clients among the multiple local clients, such that the other clients generate tree nodes with the same structure as the target client; repeating the above steps to construct multiple decision trees according to preset parameters until a federated isomorphic forest model is completed; performing prediction on a to-be-predicted test set among the multiple local clients based on the federated isomorphic forest model to obtain a yield prediction result of the target variety.

Besides, the logic instructions in the memory 530 may be implemented as a software function unit and be stored in a computer-readable storage medium when sold or used as a separate product. On the basis of such understanding, the technical solutions of the present disclosure essentially or the part contributing to the prior art may be embodied in a form of a software product. The computer software product is stored in a storage medium, and includes several instructions for enabling a computer device (which may be a personal computer, a server, a network device, etc.) to execute all or some steps of the methods described in the embodiments of the present disclosure. The foregoing storage medium includes a universal serial bus (USB) flash disk, a mobile hard disk, a read-only memory (ROM), a random access memory (RAM), a magnetic disk, an optical disc, or the like, which can store program code.

On the other hand, the present disclosure also provides a computer program product, which includes a computer program that can be stored on a non-transitory computer-readable storage medium. When the computer program is executed by a processor, the computer can perform the method for multi-organization joint variety yield prediction with data privacy protection provided by the above embodiments. The method includes: notifying multiple local clients separately based on randomly selected target samples and target features corresponding to a target variety, where a local training dataset of each local client includes the target samples and the target features; obtaining local optimal partition features transmitted by the multiple local clients to form a local partition feature set, where for each local client among the multiple local clients, the local optimal partition feature is a sample feature with a minimum degree of difference between predicted values and true values within a data range of the target samples and the target features; determining a local optimal partition feature with a minimum degree of difference in the local partition feature set as a global optimal partition feature; obtaining ciphertext sample sets of a left subtree and a right subtree transmitted by a target client corresponding to the global optimal partition feature; broadcasting the ciphertext sample sets of the left and right subtrees to other clients among the multiple local clients, such that the other clients generate tree nodes with the same structure as the target client; repeating the above steps to construct multiple decision trees according to preset parameters until a federated isomorphic forest model is completed; performing prediction on a to-be-predicted test set among the multiple local clients based on the federated isomorphic forest model to obtain a yield prediction result of the target variety.

Furthermore, the present disclosure also provides a non-transitory computer-readable storage medium that stores a computer program. When the computer program is executed by a processor, it implements the method for multi-organization joint variety yield prediction with data privacy protection provided by the above embodiments. This method includes: notifying multiple local clients separately based on randomly selected target samples and target features corresponding to a target variety, where a local training dataset of each local client includes the target samples and the target features; obtaining local optimal partition features transmitted by the multiple local clients to form a local partition feature set, where for each local client among the multiple local clients, the local optimal partition feature is a sample feature with a minimum degree of difference between predicted values and true values within a data range of the target samples and the target features; determining a local optimal partition feature with a minimum degree of difference in the local partition feature set as a global optimal partition feature; obtaining ciphertext sample sets of a left subtree and a right subtree transmitted by a target client corresponding to the global optimal partition feature; broadcasting the ciphertext sample sets of the left and right subtrees to other clients among the multiple local clients, such that the other clients generate tree nodes with the same structure as the target client; repeating the above steps to construct multiple decision trees according to preset parameters until a federated isomorphic forest model is completed; performing prediction on a to-be-predicted test set among the multiple local clients based on the federated isomorphic forest model to obtain a yield prediction result of the target variety.

The apparatus embodiment described above is merely schematic, where the unit described as a separate component may or may not be physically separated, and a component displayed as a unit may or may not be a physical unit, that is, the component may be located at one place, or distributed on multiple network units. Some or all of the modules may be selected based on actual needs to achieve the objectives of the solutions of the embodiments. A person of ordinary skill in the art can understand and implement the embodiments without creative efforts.

Through the description of the foregoing implementations, a person skilled in the art can clearly understand that the implementations can be implemented by means of software plus a necessary universal hardware platform, or certainly, can be implemented by hardware. Based on such understanding, the foregoing technical solution which is essential or a part contributing to the prior art may be embodied in the form of a software product, the computer software product may be stored in a computer readable storage medium, such as an ROM/RAM, a magnetic disk or an optical disk, including a plurality of instructions for causing a computer device (which may be a personal computer, a server, or a network device) to perform the methods described in the examples or some parts of the examples.

Finally, it should be noted that the above examples are only intended to illustrate, but not to limit, the technical solutions of the present disclosure; although the present disclosure has been described in detail with reference to the foregoing examples, those of ordinary skill in the art should understand that: the technical solutions recorded in the foregoing examples may be still modified, or some of the technical features may be equivalently substituted; these modifications or substitutions do not cause the essence of the corresponding technical solutions to depart from the spirit and scope of the technical solutions of the examples of the present disclosure.

What is claimed is:

1. A method for multi-organization joint variety yield prediction with data privacy protection, comprising:
notifying multiple local clients separately based on randomly selected target samples and target features corresponding to a target variety, wherein a local training dataset of each local client comprises the target samples and the target features;
obtaining local optimal partition features transmitted by the multiple local clients to form a local partition feature set, wherein for each local client among the multiple local clients, the local optimal partition feature is a sample feature with a minimum degree of difference between predicted values and true values within a data range of the target samples and the target features;
determining a local optimal partition feature with a minimum degree of difference in the local partition feature set as a global optimal partition feature;
obtaining ciphertext sample sets of a left subtree and a right subtree transmitted by a target client corresponding to the global optimal partition feature;
broadcasting the ciphertext sample sets of the left subtree and the right subtree to other clients among the multiple local clients, such that the other clients generate tree nodes with the same structure as the target client;
repeating the above steps to construct multiple decision trees according to preset parameters until a federated isomorphic forest model is completed; and
performing prediction on a to-be-predicted test set among the multiple local clients based on the federated isomorphic forest model to obtain a yield prediction result of the target variety.

2. The method for multi-organization joint variety yield prediction with data privacy protection according to claim 1, wherein said performing prediction on the to-be-predicted test set among the multiple local clients based on the federated isomorphic forest model to obtain the yield prediction result of the target variety comprises:
invoking the multiple local clients, and for each sample of the to-be-predicted test set, descending from a root node of each tree of the federated isomorphic forest model of the local client until all samples of the to-be-predicted test set fall into leaf nodes, to obtain a leaf node sample set;
obtaining the leaf node sample set of each local client among the multiple local clients;
performing intersection based on the leaf node sample set of each local client to obtain the to-be-predicted test set;
determining an average label value corresponding to the leaf node where each sample to be predicted in the to-be-predicted test set is located; and
determining the yield prediction result of the target variety based on the average label value corresponding to the leaf node where each sample to be predicted is located.

3. The method for multi-organization joint variety yield prediction with data privacy protection according to claim 2, wherein said descending from the root node of each tree of the federated isomorphic forest model of the local client for each sample of the to-be-predicted test set until all samples of the to-be-predicted test set fall into leaf nodes, to obtain the leaf node sample set comprises:
taking each sample of the to-be-predicted test set as a current sample and recursively executing the following steps until all samples of the to-be-predicted test set fall into leaf nodes to obtain the leaf node sample set:
when a current node of the federated isomorphic forest model of the local client carries partition information, classifying the current sample to a target leaf node based on the partition information, wherein the target leaf node comprises a left subtree leaf node and a right subtree leaf node; and
when the current node of the federated isomorphic forest model of the local client is a null node, making the current sample fall simultaneously into a left subtree leaf node and a right subtree leaf node of the null node.

4. The method for multi-organization joint variety yield prediction with data privacy protection according to claim 1, wherein before said notifying the multiple local clients separately based on the randomly selected target samples and target features corresponding to the target variety, the method further comprises:
distributing an encryption algorithm and a public key to multiple system clients;
invoking each system client among the multiple system clients to encrypt sample indices and feature encodings of a local training dataset of each system client according to the encryption algorithm and the public key, resulting in a sample index set and a feature encoding set; and
obtaining the sample index set and feature encoding set from each system client among the multiple system clients.

5. The method for multi-organization joint variety yield prediction with data privacy protection according to claim 1, wherein before said obtaining the local optimal partition features transmitted by the multiple local clients to form the local partition feature set, the method further comprises:
invoking each local client among the multiple local clients to traverse each sample value of each feature in the local training dataset;
partitioning the local training dataset into a left dataset and a right dataset based on each sample value of each feature;
calculating a sum of a mean squared error of the left dataset and a mean squared error of the right dataset as a mean squared error for each sample value; and
determining a feature corresponding to a sample value with a smallest mean squared error as a local optimal partition feature of the local training dataset.

6. The method for multi-organization joint variety yield prediction with data privacy protection according to claim 1, wherein after said broadcasting the ciphertext sample sets of the left and right subtrees to other clients among the multiple local clients, such that the other clients generate tree nodes with the same structure as the target client, the method further comprises:
when generating the tree nodes, determining generalization of a decision tree corresponding to the tree nodes based on pre-pruning conditions; and
when the generalization of the decision tree decreases, performing pruning on the tree nodes.

7. A system for multi-organization joint variety yield prediction with data privacy protection, comprising:
a notification module configured to notify multiple local clients separately based on randomly selected target samples and target features corresponding to a target variety, wherein a local training dataset of each local client comprises the target samples and the target features;
an obtaining module configured to obtain local optimal partition features transmitted by the multiple local clients to form a local partition feature set, wherein for each local client among the multiple local clients, the local optimal partition feature is a sample feature with a minimum degree of difference between predicted values and true values within a data range of the target samples and the target features;
a determining module configured to determine a local optimal partition feature with a minimum degree of difference in the local partition feature set as a global optimal partition feature;
the obtaining module being further configured to obtain ciphertext sample sets of a left subtree and a right subtree transmitted by a target client corresponding to the global optimal partition feature;
a broadcasting module configured to broadcast the ciphertext sample sets of the left subtree and the right subtree to other clients among the multiple local clients, such that the other clients generate tree nodes with the same structure as the target client;
a construction module configured to repeat the above steps to construct multiple decision trees according to preset parameters until a federated isomorphic forest model is completed; and
a prediction module configured to perform prediction on a to-be-predicted test set among the multiple local clients based on the federated isomorphic forest model to obtain a yield prediction result of the target variety.

8. An electronic device, comprising a memory, a processor, and a computer program that is stored in the memory and executable by the processor, wherein when the processor executes the computer program, the method for multi-organization joint variety yield prediction with data privacy protection according to claim 1 is implemented.

9. A non-transitory computer-readable storage medium, storing a computer program, wherein when being executed by a processor, the computer program implements the method for multi-organization joint variety yield prediction with data privacy protection according to claim 1.

10. An electronic device, comprising a memory, a processor, and a computer program that is stored in the memory and executable by the processor, wherein when the processor executes the computer program, the method for multi-organization joint variety yield prediction with data privacy protection according to claim 2 is implemented.

11. An electronic device, comprising a memory, a processor, and a computer program that is stored in the memory and executable by the processor, wherein when the processor executes the computer program, the method for multi-organization joint variety yield prediction with data privacy protection according to claim 3 is implemented.

12. An electronic device, comprising a memory, a processor, and a computer program that is stored in the memory and executable by the processor, wherein when the processor executes the computer program, the method for multi-organization joint variety yield prediction with data privacy protection according to claim 4 is implemented.

13. An electronic device, comprising a memory, a processor, and a computer program that is stored in the memory and executable by the processor, wherein when the processor executes the computer program, the method for multi-organization joint variety yield prediction with data privacy protection according to claim 5 is implemented.

14. An electronic device, comprising a memory, a processor, and a computer program that is stored in the memory and executable by the processor, wherein when the processor executes the computer program, the method for multi-organization joint variety yield prediction with data privacy protection according to claim 6 is implemented.

15. A non-transitory computer-readable storage medium, storing a computer program, wherein when being executed by a processor, the computer program implements the method for multi-organization joint variety yield prediction with data privacy protection according to claim 2.

16. A non-transitory computer-readable storage medium, storing a computer program, wherein when being executed by a processor, the computer program implements the method for multi-organization joint variety yield prediction with data privacy protection according to claim 3.

17. A non-transitory computer-readable storage medium, storing a computer program, wherein when being executed by a processor, the computer program implements the method for multi-organization joint variety yield prediction with data privacy protection according to claim 4.

18. A non-transitory computer-readable storage medium, storing a computer program, wherein when being executed by a processor, the computer program implements the method for multi-organization joint variety yield prediction with data privacy protection according to claim 5.

19. A non-transitory computer-readable storage medium, storing a computer program, wherein when being executed by a processor, the computer program implements the method for multi-organization joint variety yield prediction with data privacy protection according to claim 6.
